(19) United States
(12) Patent Application Publication
(10) Pub. No.: US 2023/0372948 A1
(43) Pub. Date: Nov. 23, 2023

(54) PROCESS FOR THE MILLING OF VEGETABLE-BASED MATERIALS, IN PARTICULAR PLANTS LIKE SEEDS

(71) Applicants: INSTITUT MUTUALISE POUR LES PROTEINES VEGETALES IMPROVE, Dury (FR); SOCIETE FINANCIERE INDUSTRIELLE, Bethune (FR)

(72) Inventors: Jean-Charles MOTTE, Jumel (FR); Denis CHEREAU, Le Touquet (FR); Franck LEROY, Sainte Catherine les Arras (FR); Jean-Francois MARECHAL, Vaudricourt (FR)

(21) Appl. No.: 18/031,272

(22) PCT Filed: Oct. 12, 2020
(86) PCT No.: PCT/EP2020/078628

§ 371 Date: Apr. 11, 2023

(51) Int. Cl. B02C 23/14; B02C 9/04; B02C 15/02; B02C 15/04; B02B 1/08; B02C 4/06; B02C 23/12

(52) U.S. Cl. CPC B02C 23/14; B02C 9/04; B02C 15/02; B02C 15/04; B02B 1/08; B02C 4/06; B02C 23/12; B02C 2015/002

(57) ABSTRACT

The Invention relates to a process for the milling of vegetable-based material, in particular plants like seeds, to produce dehulled or/and fractionate flour that includes a Material Bed Compression milling of the vegetable-based material. A first air classification of the milled material is performed to obtain a first fine fraction on one side and a first coarse fraction on the other side. A first post-treatment to the first fine fraction is then performed to obtain separate flour. The first coarse fraction is then recycled to the milling step.

### TECHNICAL FIELD OF THE INVENTION

The present invention relates to an innovative milling process to fractionate vegetable-based materials into different fractions (fibres, proteins, starches).

### BACKGROUND

Many vegetable-based foods processes include a flour production step. These flours can be the end products, considered as ingredients, or can be an intermediate product in a global process. Flour production process is thus a key step of many industries particularly since it is often considered as a high energy consumption step. The list of vegetable-based materials often transformed as flours is very diverse, but we can mention:
Cereals (wheat, buckwheat, oat, barley, corn, rice etc. . . . );
Pulses (pea, faba bean, lentils, beans, chickpea, lupin etc. . . . );
Oilseed cake (sunflower, rapeseed, soy, linseed etc. . . . );
Industrial or agricultural by-product (Malt, Bran, brewer spent grain, straw, etc. . . . ); and
Other vegetable-based materials or assimilated (algae, insects, etc. . . . ).

Three families of flours can be listed whatever agronomic resource considered: whole flours, dehulled flours and fractionated flours.

Whole flours correspond to the milling of the whole material without change in the chemical composition. The aim is only to obtain a particle size reduction. The major examples of whole flour are cereal flours like wheat or buckwheat. In those cases, the particle size targeted will be lower than 500 μm and often bellow 300 μm. The process is relatively simple since it consists in milling the entire material into flour with a specific particle size distribution. The goal is to reduce the particle size down to a value with the lowest energetic consumption and the lowest investment and process steps. For food product, the limit is often linked with fibres that are known to be milling resistant due to certain elasticity, and with the oil content that can cause powder stickiness. The present invention doesn't compete with the establish technologies on this market which are: Attrition mill, Hammer mill, Beater mill, Impact mill . . . The present invention is not really adapted to fibres, because the energy consumption would be too high for this market.

Dehulled flours correspond to the flours composed of the inner part of the seeds without the outer fibres (called hulls, husk or bran). The aim is here to remove the fibres from the product. Depending of the raw material and the fibre adherence, this dehulling process will be done either using a pre-treatment or directly during the milling. Major examples of dehulled flours are the wheat flour (as known as “T45” and “T55” flour), the dehulled pulse flours or the corn flours. Two processes exist on the market and depend only on the seed's properties: If the hulls are loose and not attached to the kernel (for example in the case of pulses such as pea, fava/Vicia faba beans or lentils), then hulls are removed before the milling. The seeds are split or coarsely broken in order to dissociate the hulls from the kernel. Hulls are then separated from the kernel using an air separation and sometime the kernel fraction is refined by an optical sorting. The hulls can be further refined by a sieving treatment or other post-treatments (air classification, electro separation, etc. . . . ). The dehulling technologies are numerous: impact dehuller, abrasion mill, roll crusher, hammer mill, stone mill, etc. The process is thus often composed of 2-3 machines before feeding the mill. Sometime, an expensive pre-treatment is required to increase separability of the hulls: steam, roasting, germination, etc. The challenge is only the one of the dehulling efficiency, the specific energy consumption, and the process simplicity.

After hulls removal, the product can be milled into flours. The goal is thus to reduce the particle size and the particle size distribution down to respective values with the lowest energetic consumption and investment/process steps). A large variety of mills will then be possible: Attrition mill, Hammer mill, Beater mill, pin mill, impact mill or roller mill for example.

When hulls are strongly attached to the kernel (for example in the case of cereals or oilseeds), then hulls need to be removed during the milling. The goal is to produce two fractions: the hulls (also called bran or husk) and the fibre-free flour.

In the past, stone mills were used to product cereal flours. The compression and friction forces of the stones were used to crush the seeds. The fibres were then separated from the flour by sieving. The stone mill process is limited by its maximal capacity (often hundred kilos per hours per equipment maximum), the high energy consumption (75 kWh/ton) to set a heavy stone of several tons under rotation. The present invention can be seen as the modern, safe, optimized and robust version of the stone milling process.

The stone mills were replaced in the 20th century by a milling diagram often composed of multiple rolls used to mill the kernel with a perseveration of the hulls. Roller mill process is often used to process wheat but also cereals pulses and oil seeds meal. The milling is thus very progressive thanks to multiple machines (up to 16 mills and 24 sieving). A pre-treatment of the material is often required through an adjustment of the moisture content to control the elasticity of the fibres. Generally, moisture content is adjusted between 14 and 17%, and preferably between 15.5 and 16% of humidity. The contact time is often of few hours (between 1 h and 36 h but preferably between 4 h and 18 h). Despite this process complexity, the energy consumption is considered as low (about 35 kWh/ton) and the challenges are the control of the product quality often measured by the content of fibre in the flour and the yields. Multiple operations imply a constant (an often manual) supervision of the mill and a significant building size (generally 4 levels to use gravity as much as possible and thus reducing the product transport cost).

Several attempts to simplify the wheat flour production process have been made by many equipment providers. One of them proposed by Buhler (Alpesatm) consists in a compact line composed of a high compression rolls mill, a detacher and a sifter. The desired product is removed while the intermediate fraction is sent back to the roll mill using a recycling loop. This process is interesting for its limited footprint, but is limited by its energy consumption of 70 kWh/ton and its maximal capacity of 700 kg/h.

The process “moulin F10” developed by Anutec consists in the use of a pin mill coupled with a sifter. The moisture adjustment can be made with steam at 60° C. max during only 10 min. The pin mill is set at 165 m/s. The process produces grey flour at 80% yield. The limit of this process is the flour quality, but the company is claiming a significant energy consumption reduction compared to small roller mill lines working at 160 kWh/ton. This process is interesting for its limited foot print and low investment, but the poor quality of the flour is a limit as well as the maximal capacity for a single unit which will be of about 2 ton/h.

The fractionated flours family corresponds to the production of flours enriched in protein, starch and/or fibre. The aim is to create fractions enriched in protein, starch or fibre. Major examples of fractionated flours are the pea protein concentrates, the gluten-rich wheat flours, or the sunflower and rapeseed protein concentrates.

The classical strategy is to deconstruct the material to separate a fine fraction and a coarse fraction with different chemical compositions. The process often starts with dehulled flour, so it needs to include a full dehulling line. The process is generally composed of a micronation stage (PSD, i.e. Particles Size Distribution, often <50 μm) coupled with a separator that can be air classification and/or electro separation. The challenge is to separate some compounds (protein for example) into fractions having different particle sizes or electrostatic behaviour than other compounds (starch or fibres). The particle size is most of the time used as an indicator. However, for such topic, the real target is to separate particles based on their size but also their density. Indeed, the real challenge is the protein/starch/fibres deconstruction. Protein should be milled while internal fibres and starch should be preserved. Thus, the milling step is a key point. It is usually done by an impact mill (classical solution), an attrition mill (lower energy consumption) or a double pin mill (better product quality). The separation is then done by air classifier or possibly electrostatic separators. The energy consumption is a major point of attention of these processes.

The present invention competes with the state-of-the-art approaches. It corresponds to an innovative milling approach that combined advantages of a low energy consumption and the excellent fibre/starch/protein separation.

### SUMMARY OF THE INVENTION

The present invention competes with all the approaches when a dehulled flour is required (no possibility to produce split for example). Indeed, the invention allows the milling simultaneously to hulls separation for most of the resources (cereals, pulse, and oilseed products). The milling is conducted to produce a flour of few hundred microns while producing the hulls as coarse fragments of few millimetres. The process contains fewer machines than conventional processes and has a limited footprint. The energy consumption of the whole process is also one of the lowest of all existing machines. It can be also fully automated and can process important quantities of product (up to 10 ton/h per equipment.

To this end, according to a first aspect, the present invention relates to a process for the milling of vegetable-based material, in particular plants like seeds, to produce dehulled or/and fractionate flour, comprising the steps of:
performing a Material Bed Compression (MBC) milling of the vegetable-based material,
performing a first air classification of the milled material to obtain a first fine fraction on one side and a first coarse fraction on the other side,
performing a first post-treatment to the first fine fraction to obtain separate flour, and
recycling the first coarse fraction to the milling step.

The invention shall be implemented according to the different embodiments and variations set out below, which are to be considered individually or in any technically effective combination.

Advantageously, the material being dehulled pea seeds, the first post-treatment consists of a second air classification step for producing a second coarse fraction of starch flour on one side and a second fine fraction of protein flour on the other side.

Preferably, the process further comprises, before the step of Material Bed Compression milling, a step of mixing the vegetable-based material with water to hydrate the mix, and stabilizing said hydrated mix.

According to another embodiment, said material being wheat grain, the first post-treatment delivers wheat bran on one side and wheat flour on the other side.

In a preferred manner, the process further comprises the steps of:
performing a second air classification to the first coarse fraction to obtain a second fine fraction on one side and second coarse fraction on the other side,
performing a second post-treatment to the second fine fraction to obtain wheat bran on one side and wheat flour on the other side, and
recycling the second coarse fraction to the milling step.

According to another embodiment, said material being peas grain, the first post-treatment delivers peas hull on one side and peas flour on the other side.

Preferably, the process further comprises a step of sieving the first coarse fraction to obtain peas hulls on one side and an intermediary fraction on the other side.

According to a particular aspect of the present invention, the process further comprises the steps of:
performing a second air classification to the intermediary fraction just after the sieving step to obtain a second fine fraction on one side and a second coarse fraction on the other side,
performing a second post-treatment to the second fine fraction to obtain peas hulls on one side and peas kernel grits on the other side, and
recycling the second coarse fraction and the peas kernel grits to the milling step.

According to another embodiment, said material being sunflower, the first post-treatment delivers fibres on one side and sunflower protein flour on the other side.

In an advantageous manner, the process further comprises a step of sieving the first coarse fraction to obtain fibres on one side and an intermediary fraction on the other side.

In particular, the process further comprises the steps of:
performing a second air classification to the intermediary fraction just after the sieving step to obtain a second fine fraction on one side and a second coarse fraction on the other side,
performing a second post-treatment to the second coarse fraction to obtain fibres on one side and sunflower grits on the other side, and
recycling the second fine fraction and the sunflower grits to the milling step.

According to another embodiment, said material being pulse seeds, the process further comprises, after the first air classification, the steps of:
sieving the first coarse fraction to obtain whole or semi whole flour on one side and an intermediary fraction on the other side, and
recycling the intermediary fraction to the milling step.

### BRIEF DESCRIPTION OF THE DRAWINGS

Other advantages, purposes and characteristics of the present invention are apparent from the following description made, for explanatory purposes and in no way limiting, against the annexed drawings, in which:

FIG. 1 is a general scheme of the present invention,

FIG. 2 is a scheme of a first example,

FIG. 3 is a scheme of a second example,

FIG. 4 is a scheme of a third example,

FIG. 5 is a scheme of a fourth example,

FIG. 6 is a comparison table,

FIG. 7 is another comparison table,

FIG. 8 is a scheme of a fifth example, and

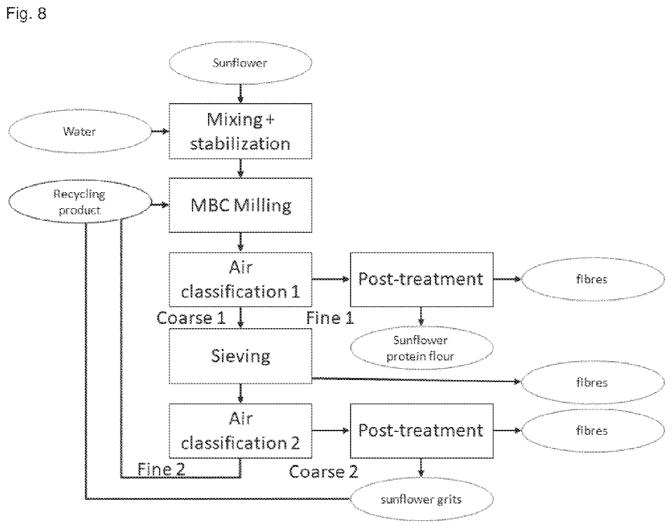

FIG. 9 is a scheme of a sixth example.

### DETAILED DESCRIPTION OF THE EMBODIMENTS

The present invention is composed of a Material Bed Compression (MBC) mill (for example: pendulum mill, vertical roller mill, horizontal roller mill, hydraulic roller press) coupled with air classifier(s) and/or sieving steps. This milling compression process was chosen for its ability to maximize the flour heterogeneity and for its low specific energy consumption (kWh/ton).

The MBC mill is a technology commonly used in the mineral industry since decades. It was a revolution in the 90's in the cement industry since it replaced the ball mills (low cost but with high energy consumption). Its advantages are its high robustness, its low maintenance frequency, and the low specific energy consumption.

In vegetable-based material milling, the flour production is often a matter of fibre preservation rather than a specific particle size to reach. However, the fibre preservation creates highly heterogeneous flours that are avoided by mill providers and mills users.

The principle of the invention is thus to exploit this powder heterogeneity on vegetable-based materials to have an advantage in term of product quality, process efficiency and process cost.

The process is composed of:
A moisture adjustment step to control the fibre elasticity and thus preservation into the mill,
A MBC mill, that works on the compression principle since it is efficient in particle size reduction of brittle fractions (flours) while preserving the fibre fraction size,
An air-classifier set to control residence time of each fraction into the mill thanks to a control of both particle size and density, and
Several post-treatments to refine air classifier rejects (for hulls removal) by sieving, air classification or electro-separation.

Material Bed Compression (MBC) mill uses compression and friction forces (without sliding) applied on a compacted bed of material (the bed thickness ranging from 10 mm to 100 mm depends on the size of the mill) at a low rolling speed (lower than 10 m/s).

The MBC mill process brings a better preservation of the starch and fibres, compared with other grinding process (ex: high speed impact and/or attrition).

The MBC mill also brings a better efficiency and consequently reduces the electrical power consumption per ton of production, compared with other grinding processes. Indeed, maximum of power rate is directly transmitted to the material bed.

The MBC mill process with a low speed compression of a material bed brings a low rate of abrasion, which increases the lifetime of the grinding media and consequently reduces contamination of the product, compared with other milling process and reduce maintenance costs.

The MBC mill chamber volume (example: pendulum mill, vertical roller mill) can be used to simultaneously dry the product during the grinding process, by using hot gas at the inlet of the mill. As an alternative or complement, in case of MBC chamber volume too small or absent, the drying capacity can be also done into the dynamic classifier gas circuit.

The drying rate can be controlled by a temperature setpoint located at the outlet of the mill or classifier.

A dynamic classifier can be associated with the MBC mill to produce the flour. The flour fineness is managed by the classifier setting (gas-flow control, classifier turbine speed control). This solution brings two main advantages compared with a milling solution without classifier:
1^{st} advantage is a stable product quality, whatever the material behaviour fluctuations are. Harder/Softer is the material, higher/lower will be the circulating load coming back from the classifier to the mill to keep a constant flour fineness;
2^{nd} advantage is the capability to fully feed the mill up to its nominal power, in order to maximize the production capacity, while the product fineness is still insured by the classifier, compared with a solution without any classifier where the mill must manage as well the product fineness which can limit the feed and prevent using the mill nominal power.

The invention is mostly adapted for two cases: dehulled flours production and fractionated flours production.

The invention consists in a milling process able to mill vegetable-based materials (plants for example, especially seeds) into flour with a maximal preservation of the fibre. This process is adapted to many known applications but provides every time a significant improvement in term of quality, yield, investment, or operating cost. The invention is applicable every time a fibre fraction should be removed from a vegetable-based material flour production.

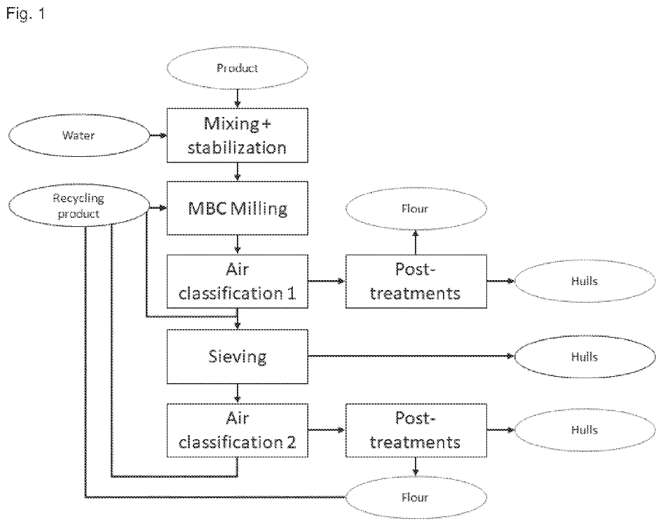

The general process described in FIG. 1 consists in:
An optional but recommended conditioning step where the product is prepared for the milling. The preparation often consists in a hydration phase. This increase of moisture content aims to make the fibres softer and more elastic to increase the fibre preservation during the milling. The moisture adjustment is limited to few percent's (+1% to +10%) with a contact time comprise between few minutes (1 minute) to several hours (up to 36 hours) but often between 30 minutes and 18 hours. The moisture adjustment can be coupled with another treatment such as steam, de-bacterization (ozone, bleach, etc.), microwaves, germination, etc;
A MBC milling step. This mill works with compression and friction forces applied by roller(s) on a bed of particles. The force is fixed (typically by a hydraulic jack source, or a centrifugal force for pendulum mill) and bed thickness is free (typically ranging from 10 to 100 mm depending on the roller size). The rolling force of the roller on the bed material induces a compression and friction stress (without sliding) through all the particles under the roller. It is thus different from roller mill (fixed gap between rolls) when the material is in contact with the steel. Major part of MBC mills family (ex: pendulum mill or vertical roller mill) also uses a high ventilation that avoid a too high heating temperature, and which can be used to dry the product. This ventilation flow is also used for product transportation of particles up to the classifier. As an example, the MBC mill can be the POITTEMILL patented Carousel pendulum mill model, with its externalized driving mechanic and oil lubrication to avoid the risk of product pollution;
One dynamic classification step. An air classifier will collect the product coming out of the mill and separate the product into two fractions. The fractions repartition, called cut-size, can be set by the classifier turbine speed adjustment. The fine fraction is generally composed of flour and big hulls fragments or, if an ultrafine milling is targeted, it will be composed of protein fractions. The coarse fraction is composed of products not fine enough or not dissociated enough. These two fractions are post-treated to refine them.

The coarse fraction coming out of the first classifier can be:
Post-processed on a sieving stage or electro-separation to remove coarse hulls fragment. This fraction can contain some big kernel fragments and can be post-processed on a second classifier set to remove light fraction and thus recycling the kernel to the MBC mill;
Post-processed on a second air classifier set to remove fine fraction (that can be starch fraction or any intermediate fraction). The coarse fraction of this second air classifier is recycled into the MBC mill to be milled again. This second post-process is described into a separated POITTEMILL double classification patent;
Post-process on a second air classifier to remove coarse fraction (that can be the coarser fibres fraction), the fine fraction of the second air classifier is recycled into the MBC mill to be milled again. This third post-process is described into a separated POITTEMILL double classification patent; and
Recycled as it is in the MBC mill, to be milled again.

The fine fraction can be composed of flour and hulls, dehulled flours or protein concentrate. This fraction can be post-processed by sieving, air classification and/or an electrostatic separation. This post-treatment aims to remove fine fibres generated during the process. Further post-treatment that does not affect chemical composition is not part of the invention.

The general process scheme with all its options is illustrated by FIG. 1. All options (lines) are in the following figures, but they are not activated altogether. Therefore, the invention includes its simplification applied to vegetable-based materials milling. The examples hereafter highlight the adaptation of this general process scheme to specifics situations.

### Example 1: Dehulling of Wheat Flour from Wheat Grain

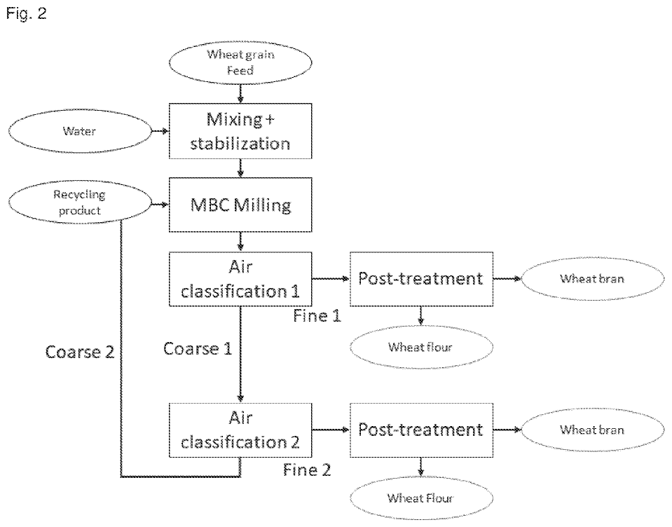

When applied to wheat flour production, the innovative scheme process according to FIG. 2 is used to produce white or grey flour with a significant simplification of the conventional roller mill process.

The process consists in:
An optional but recommended conditioning step where the wheat grain is prepared for the milling. The preparation consists in a hydration phase. This increase of moisture content aims to make the fibres softer and more elastic to increase the fibre preservation during the milling. The moisture adjustment is of few percents (+1% to +10%) with a contact time comprise between few minutes (1 minute) to several hours (up to 36 hours) but often between 30 minutes and 18 hours. The moisture adjustment can be couple with another treatment such as steam, de-bacterization (ozone, bleach . . . ), microwaves, germination, etc;
A MBC milling step, as already described;
One dynamic classification step. An air classifier will collect the product coming out of the mill and separate the product into two fractions. The fine fraction is generally composed of flour and big hulls fragments. The coarse fraction is composed of products not fine enough or not dissociated enough. These two fractions are post-treated to refine them;
The coarse fraction coming out of the first classifier is post-processed on a second classifier set to remove fine fraction (that can be starch fraction or any intermediate fraction). The coarse fraction of this second classifier is recycled in the MBC mill;
The fine fractions can be composed of flour and hulls fragments. These fractions can be post-processed by sieving, air classification and/or an electrostatic separation. This post-treatment aims to remove fine fibres generated during the process. Further post-treatment that does not affect chemical composition is not part of the invention.

This process can be applied with minor modifications to all native or processed cereals, pulses, oil seed cake and meal and some industrial by-products.

In the following example, wheat moisture content was adjusted at 15.5% with a contact time of 18 hours. The MBC milling was done with a pendulum mill. The first classifier turbine was set to produce flour 0-300 μm and the second classifier set to extract a maximum of bran. Each air classifier collects its fine fraction that is then sieved at 200 μm. Flour was collected on sieves passing fraction, while bran was collected on sieves retained fraction. Mill specific power consumption is 32 kWh/t.

The process produces wheat flours at high yield (71.5%-23.8% of bran) with an ash content of 0.95%. The level of damage starch is relatively low at 10.22% (starch basis).

### Example 2: Dehulling of Pea Flour from Pea Grain

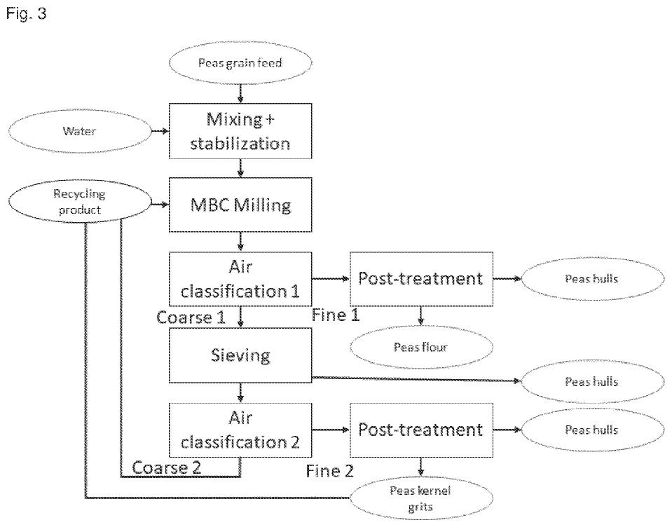

When applied to dehulled pea flour production, the innovative scheme process according to FIG. 3 is a major simplification of the conventional process. Indeed, the dehulling and milling process is done in few steps comparing to conventional process composed of a dehulling line followed by a milling line. It is also of lower energy consumption.

The process consists in:
An optional but recommended conditioning step where the pea grain is prepared for the milling. The preparation often consists in a hydration phase. This increase of moisture content aims to make the fibres softer and more elastic to increase the fibre preservation during the milling. The moisture adjustment is of few percents (+1% to +10%) with a contact time comprise between few minutes (1 minute) to several hours (up to 36 hours) but often between 30 minutes and 18 hours. The moisture adjustment can be couple with another treatment such as steam, de-bacterization (ozone, bleach etc.), microwaves, germination, etc;
A MBC milling step, as already described;
One dynamic classification step. An air classifier will collect the product coming out of the mill and separate the product into two fractions. The fine fraction is generally composed of flour and big hulls fragments or, if an ultrafine milling is targeted, it will be composed of protein fractions. The coarse fraction is composed of products not fine enough or not dissociated enough. These two fractions are post-treated to refine them;
The coarse fraction coming out of the first air classifier can be post-processed on a sieving stage to remove coarse hulls fragment. This fraction can contain some big kernel fragments and can be post-processed on a second air classifier set to remove light fraction and thus recycling the kernel grits to the mill;
The fine fraction can be composed of flour and hulls fragments. This fraction can be post-processed by sieving and/or an electrostatic separation. This post treatment aims to remove fine fibres generated during the process. Further post-treatment that does not affect chemical composition is not part of the invention.

In the following example, pea moisture content was adjusted at +3% with a contact time of 1 hour. The MBC milling was done with a pendulum mill. The first classifier turbine was set to produce flour 0-50 μm and a 2 mm sieve is used to extract 6% of hulls from the feed (without any 2^{nd} air classifier).

The process produces a dehulled peas flour 0-50 μm, for a mill specific power consumption of 63 kWh/t.

The same process can be also used to produce dehulled peas flour 0-315 μm with a mill specific power consumption of 23 kWh/t.

### Example 3: Producing Pea Protein Concentrate from Pea Seeds

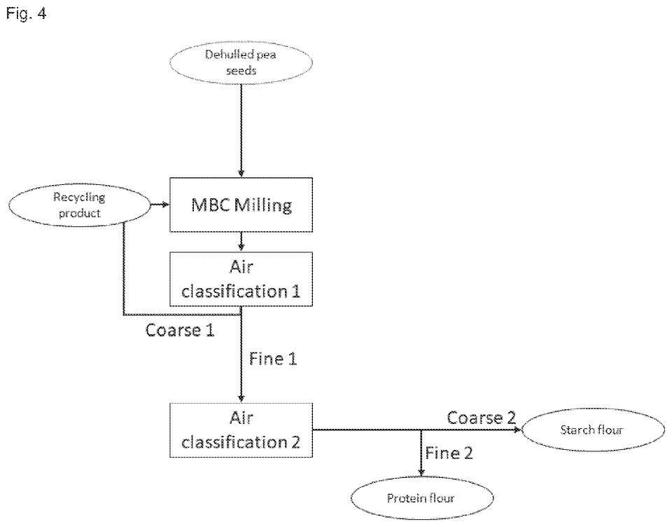

When applied to pea protein concentrate production, the innovative scheme process according to FIG. 4 provides a significant energy saving and a higher efficiency compared to conventional processes.

The process consists in:
A dehulling step where the product is prepared for the milling. The dehulling can be couple with another treatment such as steam, de-bacterization (ozone, bleach, etc.), microwaves, germination, etc;
A MBC milling step, as already described;
One dynamic classification step. An air classifier will collect the product coming out of the mill and separate the product into two fractions. The fine fraction is generally composed of flour containing the dissociated proteins particles. The coarse fraction is composed of products not fine enough or not dissociated enough;
The coarse fraction coming out of the first classifier is recycled in MBC mill;
The fines fractions can be composed of fine protein particles and coarse starch and fibre particles. These fractions are post-processed by a second air classification. This post-treatment aims to extract protein in fine fraction and starch and fibre in coarse fraction;
Remaining fibres in both fine and coarse fractions can be removed by an electrostatic separation generated during the process. Further post-treatment that does not affect chemical composition is not part of the invention.

In the following example, the milling of dehulled peas seeds containing proteins was done with a pendulum mill. The first classifier turbine was set to produce flour 0-50 μm and the second classifier was set to extract the concentrate proteins flour. Mill specific power consumption is 41 kWh/t.

The process produce a 55% concentrate protein flour at a high yield (55-65%). The level of damaged starch is relatively low at 5.7% (starch basis).

### Example: Producing Sunflower Protein Concentrate

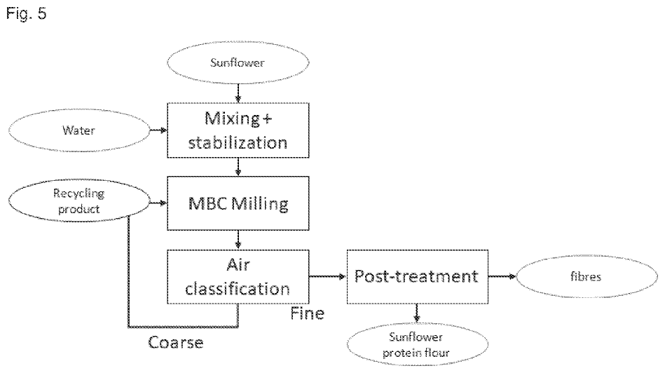

When applied to sunflower meal concentrate production, the innovative scheme process according to FIG. 5 provides a significant energy saving and a higher efficiency compared to conventional processes.

The process consists in:
An optional but recommended conditioning step where the product is prepared for the milling. The preparation consists in a hydration phase. This increase of moisture content aims to make the fibres softer and more elastic to increase the fibre preservation during the milling. The moisture adjustment is of few percent's (+1% to +10%) with a contact time comprise between few minutes (1 minute) to several hours (up to 36 hours) but often between 30 minutes and 18 hours. The moisture adjustment can be couple with another treatment such as steam, de-bacterization (ozone, bleach, etc.), microwaves, germination, etc;
A MBC milling step, as already described;
One dynamic classification. An air classifier will collect the product coming out of the mill and separate the product into two fractions. The fine fraction is generally composed of flour and fibres fragments. The coarse fraction is composed of products not fine enough or not dissociated enough;
The coarse fraction is directly recycled into the mill;
The fine fraction can be composed of flour and hulls, dehulled flours or protein concentrate. This fraction can be post-processed by sieving, or a second air classification and/or an electrostatic separation. This post-treatment aims to remove fine fibres generated during the process. Further post-treatment that does not affect chemical composition is not part of the invention.

In the following example, sunflower meal moisture content was not adjusted.

The milling was done with a pendulum mill. Only one classifier was used and set to produce flour 0-500 μm. The coarse fraction is sent back to the mill. The fine fraction coming out of the classifier is sieved at 125, 180, 250 and 315 μm.

Mill specific power consumption is 30 kWh/t.

The process produces protein-rich fraction at similar yield and quality than a roller mill diagram. The installation is smaller, and specific power consumption is lower.

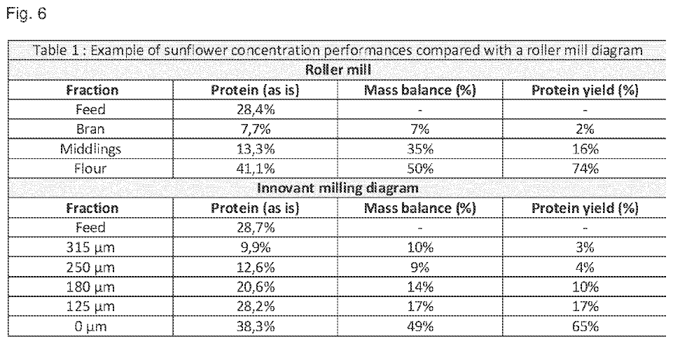

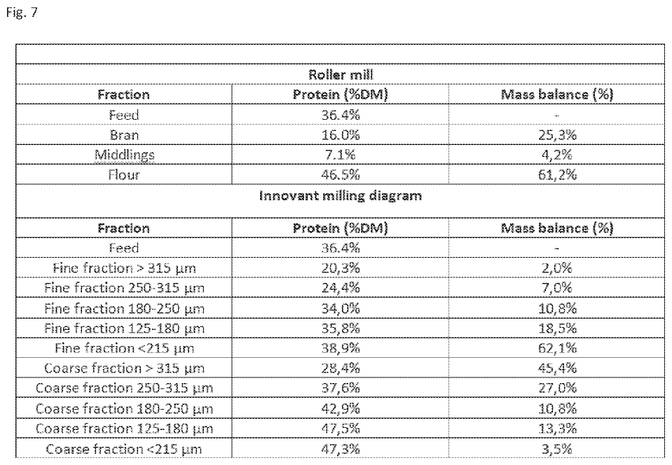

FIGS. 6 and 7 show two different tables issued from an example of sunflower concentration performance compared with a roller mill diagram.

### Example 5: Variation of Producing Dehulled Sunflower Protein

In this particular embodiment according to FIG. 7, the first coarse fraction coming out of the first air classifier can be post-processed on a sieving stage to remove coarse fibre fragment. This fraction can contain some big sunflower fragments and can be post-processed on a second air classifier set to remove light fraction and thus recycling the sunflower grits to the mill. The fine fraction coming out of the second air classifier is recycled into the mill. The coarse fraction is post-processed by sieving and/or an electrostatic separation. Further post-treatment that does not affect chemical composition is not part of the invention

This option strongly reduces the mill specific power consumption (approx. by 40% with sunflower meal).

### Example 6: Producing Pulse Protein at Low Costs

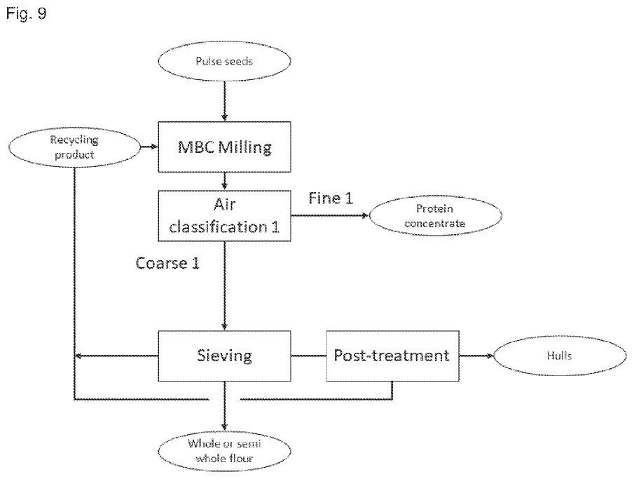

When applied to pulse protein concentrate production, the innovative scheme process according to FIG. 9 provides a significant energy saving and compared to conventional processes.

The process consists in:
An optional but recommended conditioning step where the product is prepared for the milling. The preparation consists in a hydration phase. This increase of moisture content aims to make the fibres softer and more elastic to increase the fibre preservation during the milling. The moisture adjustment is of few percent's (+1% to +10%) with a contact time comprise between few minutes (1 minute) to several hours (up to 36 hours) but often between 30 minutes and 18 hours. The moisture adjustment can be couple with another treatment such as steam, de-bacterization (ozone, bleach, etc.), microwaves, germination, etc;
A MBC milling step, as already described;
One dynamic classification. An air classifier will collect the product coming out of the mill and separate the product into two fractions. The fine fraction is generally composed of protein rich fraction. The coarse fraction is composed of flour and hulls;
The coarse fraction is sieved to collect a flour fraction and hulls while the intermediate fraction are recycled into the mill;
The hulls fraction can be composed of flour and hulls. This fraction can be post-processed (by a gravity classifier for example) to purify the hulls and recycle into the mill the big kernel fragments.

The process schemes according to the present invention rest on a specific mill innovation in the vegetable-based materials milling, giving multiple options for streams pre-treatment or post-treatment.

The process uses compression forces to mill the flour fraction while preserving the fibres. Separation steps allow to manage the flour fineness and to remove fibres from the flours and pre-treatments increase the level of fibre preservation. The process can be fully automated, is robust and the global energy consumption is lower than classical processes.

The application of this technology will be central in each process using vegetable-based flours and production of ingredients such as the production of dehulled flours, white flours, protein concentrates, optimal flours for protein isolates and starch purification.

It shall be understood that the detailed description of the subject matter of the Invention, given solely by way of illustration, shall in no way constitute a limitation, the technical equivalents also being within the scope of the present invention.

1. A process for the milling of vegetable-based material, in particular plants like seeds, to produce dehulled or/and fractionate flour, the process comprising:
performing a Material Bed Compression (MBC) milling of the vegetable-based material,
performing a first air classification of the milled material to obtain a first fine fraction on one side and a first coarse fraction on the other side,
performing a first post-treatment to the first fine fraction to obtain separate flour, and
recycling the first coarse fraction to the milling step.

2. The process according to claim 1, wherein the material being dehulled comprises pea seeds, and the first post-treatment consists of a second air classification for producing a second coarse fraction of starch flour on one side and a second fine fraction of protein flour on the other side.

3. The process according to claim 1, further comprising before the MBC milling, mixing the vegetable-based material with water to hydrate the mix, and stabilizing said hydrated mix.

4. The process according to claim 3, wherein said material comprises wheat grain, and the first post-treatment delivers wheat bran on one side and wheat flour on the other side.

5. The process according to claim 4, further comprising:
performing a second air classification to the first coarse fraction to obtain a second fine fraction on one side and second coarse fraction on the other side,
performing a second post-treatment to the second fine fraction to obtain wheat bran on one side and wheat flour on the other side, and
recycling the second coarse fraction to the milling step.

6. The process according to claim 3, wherein said material comprises peas grain, and the first post-treatment delivers peas hull on one side and peas flour on the other side.

7. The process according to claim 6, further comprising sieving the first coarse fraction to obtain peas hulls on one side and an intermediary fraction on the other side.

8. The process according to claim 7, further comprising:
performing a second air classification to the intermediary fraction just after the sieving to obtain a second fine fraction on one side and a second coarse fraction on the other side,
performing a second post-treatment to the second fine fraction to obtain peas hulls on one side and peas kernel grits on the other side, and
recycling the second coarse fraction and the peas kernel grits to the milling step.

9. The process according to claim 3, wherein said material comprises sunflower, and the first post-treatment delivers fibres on one side and sunflower protein flour on the other side.

10. The process according to claim 9, further comprising sieving the first coarse fraction to obtain fibres on one side and an intermediary fraction on the other side.

11. The process according to claim 10, further comprising:
performing a second air classification to the intermediary fraction just after the sieving to obtain a second fine fraction on one side and a second coarse fraction on the other side,
performing a second post-treatment to the second coarse fraction to obtain fibres on one side and sunflower grits on the other side, and
recycling the second fine fraction and the sunflower grits to the milling step.

12. The process according to claim 1, wherein the material comprises pulse seeds, the process further comprising, after the first air classification:
sieving the first coarse fraction to obtain whole or semi whole flour on one side and an intermediary fraction on the other side, and
recycling the intermediary fraction to the milling step.
